(19) United States
(12) Patent Application Publication
(10) Pub. No.: US 2026/0264567 A1
(43) Pub. Date: Sep. 10, 2026

(54) CONTROL SYSTEM, CHARGING UNIT, SERVER, AND METHOD FOR ELECTRICAL LOAD MANAGEMENT

(71) Applicant: Caterpillar Inc., Peoria, IL (US)

(72) Inventors: Russell Allen Brockhurst, Carindale (AU); David Gordon Crabb, Prangins (CH)

(73) Assignee: Caterpillar Inc., Peoria, IL (US)

(21) Appl. No.: 19/073,096

(22) Filed: Mar. 7, 2025

(51) Int. Cl. B60L 58/13; B60L 53/63; B60L 53/66

(52) U.S. Cl. CPC B60L 58/13; B60L 53/63; B60L 53/66; B60L 2200/40; B60L 2240/66; B60L 2240/72; B60L 2260/44; B60L 2260/54

(57) ABSTRACT

A control system for electrical load management is disclosed. The control system is configured to determine operating condition(s) associated with charging unit(s). The operating condition(s) comprises a current electrical load, power availability, and operation time, a projected electrical load, and power availability, and/or a count and a current state of charge (SoC) of connected battery electric machine(s) (BEMs). The control system is also configured to assign a first target SoC or a second target SoC corresponding to the at least one battery electric machine based on the determined operating condition(s). The second target SoC is greater than the first target SoC by at least a predefined threshold. Further, the control system is configured to initiate charging of the BEM(s), via the charging unit(s), up to the first target SoC or the second target SoC, or discontinue the charging based on the assignment and the determined operating condition(s).

### TECHNICAL FIELD

The present disclosure relates, in general, to electric power management. More particularly, the present disclosure related to a control system, a charging unit, and a method for electrical load management.

### BACKGROUND

An electrified worksite such as an underground electrified mine site may experience periods of fluctuating power supply from or available power at different power sources provided within the electrified worksite. Similarly, the electrified worksite may also experience periods of fluctuating electrical loads acting on the power sources due to a fluctuating count of electric equipment, machinery, or machines connected to and drawing power from the power sources at different periods of time and at different power consumption rates. The fluctuations in power supply and/or the electrical loads may result in underutilization or overutilization of the available power from the power sources during the different periods of time. The overutilization of the available power during certain time periods may cause undesirable production delays due to, for example, delayed movement of battery electric machines (BEMs) connected to the charging units, movement of the BEMs at reduced speeds or minimal operations of the BEMs due to unavailability of charging units for charging, or queuing or reduced charging rates of the BEM(s) at charging stations powered by the power sources. The overutilization of the available power may also impact production costs in terms of increased power tariffs during the periods of overutilization. In addition, the overutilization of the available power may also warrant an upgrade of existing power distribution infrastructure within the electrified worksite or may lower an average electrical load factor or utilization of supplementary power distribution infrastructure introduced within the electrified worksite, thereby resulting in an increase in associated infrastructure upgrade and/or investment costs. Similarly, the underutilization of the available power during time periods of continuous power generation or supply from the power sources may lead to overutilization of the available power during time periods of limited power supply or generation from the power sources. In addition, both the overutilization and the underutilization of the available power may impact an electrical load factor corresponding to a ratio of peak electrical load to an average electrical load on the power sources over a time period. The electrical load factor, in turn, impacts the infrastructure upgrade and/or investment costs.

PCT publication WO2023049998, herein referred to as the “WO '998 reference”, relates to a system and method for directing energy use within a facility comprising charging stations for charging a fleet of electric vehicles, using an energy optimization engine. The energy optimization engine receives energy supply characteristics and facility operational energy consumption characteristic of energy assets associated with the facility over a first time period, and electrical vehicle operational requirements for the electric vehicles during a second period. The energy optimization engine computes energy distribution instructions for the first time period satisfying a designated energy condition corresponding at least in part with the energy supply characteristics. The energy optimization engine also directs operation of the charge stations or the energy assets in accordance with the energy distribution instructions. The energy distribution instructions and the charging station instructions, as described in the WO '998 reference, are directed towards prioritizing charging, operations to be performed, or a charging schedule of one or more electric vehicles based on the operational needs or energy costs involved during periods of surplus or limited power. However, in continuous production environments, it may be undesirable to reprioritize and/or reschedule operations or charging of electric vehicles. Further, in the continuous production environments, unexpected changes or events occurring during the first time period may produce undesirable results or impacts in productivity or operation efficiency in view of the prior energy distribution instructions and the charging station instructions received corresponding to the first time period.

### SUMMARY

In an aspect of the present disclosure, a control system for electrical load management is disclosed. The control system includes a processor and a memory for storing instructions that when executed by the processor, causes the processor to determine at least one operating condition associated with at least one charging unit in communication with the processor. The at least operating condition includes a current electrical load on at least one power source associated with the at least one charging unit, a current availability of electrical power from the at least one power source, a current time period of operation of the at least one charging unit, a count of at least one battery electric machine (BEM) connected to the at least one charging unit and in communication with the processor, a current state of charge of the at least one connected BEM, a projected electrical load on the at least one power source, and/or a projected availability of the electrical power from the at least one power source over a predefined time period. The processor is also configured to assign a first target state of charge or a second target state of charge corresponding to the at least one connected BEM based on the at least one determined operating condition. The second target state of charge is greater than the first target state of charge by at least a predefined threshold. The processor is also configured to initiate charging of the at least one BEM, via the at least one charging unit, up to the first target state of charge or the second target state of charge, or discontinue the charging based on the assignment and the at least one determined operating condition.

In another aspect of the present disclosure, a charging unit for electrical load management is disclosed. The charging unit includes at least one power source, at least one power outlet, and a control system in communication with the at least one power source. The control system is configured to determine at least one operating condition of the at least one charging unit. The at least operating condition includes a current electrical load on the at least one power source, a current availability of electrical power from the at least one power source, a current time period of operation of the at least one charging unit, a current count of at least one battery electric machine connected to the at least one charging unit via the at least one power outlet and in communication with the control system, a current state of charge of the at least one connected battery electric machine, a projected electrical load on the at least one power source, and/or a projected availability of the electrical power from the at least one power source over a predefined time period. The control system is also configured to assign a first target state of charge or second target state of charge corresponding to the at least one connected battery electric machine based on the at least one determined operating condition. The second target state of charge is greater than the first target state of charge by at least a predefined threshold. The control system is also configured to initiate charging of the at least one battery electric machine, via the at least one power source and the at least one charging unit, up to the first target state of charge or second target state of charge or discontinue the charging based on the assignment and the at least one determined operating condition.

In yet another aspect of the present disclosure, a server for electrical load management of at least one power source is disclosed. The serve includes a control system, at least one independent power source in communication with the control system, and at least one charging unit in communication with the control system. The control system is configured to determine at least one operating condition associated with the at least one charging unit. The at least operating condition includes a current electrical load on the at least one power source and the at least one independent power source, a current availability of electrical power from the at least one power source and at least one independent power source, a current time period of operation of the at least one charging unit and at least one independent power source, a current count of at least one battery electric machine connected to the at least one charging unit and in communication with the control system, a current count of at least one electrical device or machinery connected to the at least one independent power source, a current state of charge of the at least one connected battery electric machine, a projected electrical load on the at least one power source and the at least one independent power source, or a projected availability of the electrical power from the at least one power source and the at least one independent power source over a predefined time period. The control system is also configured to assign a first target state of charge or second target state of charge corresponding to the at least one connected battery electric machine based on the at least one determined operating condition. The second target state of charge is greater than the first target state of charge by at least a predefined threshold. Further, the control system is configured to initiate charging of the at least one battery electric machine, via the at least one charging unit, up to the first target state of charge or second target state of charge, or discontinue the charging based on the assignment and the at least one determined operating condition.

In yet another aspect of the present disclosure, a method for electrical load management is disclosed. The method includes a step of determining, via a processor of a control system, at least one operating condition of the at least one charging unit in communication with the processor. The at least operating condition includes at least one of a current electrical load on at least one power source associated with the at least one charging unit, a current availability of the electrical power from the at least one power source, a current time period of operation of the at least one charging unit, a current count of at least one battery electric machine connected to the at least one charging unit, a current state of charge of the at least one connected battery electric machine, or a projected electrical load on the at least one power source or a projected availability of the electrical power from the at least one power source over a predefined time period. The method also includes a step of assigning, via the processor, a first target state of charge or second target state of charge corresponding to the at least one connected battery electric machine based on the at least one determined operating condition. The second target state of charge is greater than the first target state of charge by at least a predefined threshold. Further, the method includes a step of charging, via at least one charging unit, the at least one battery electric machine up to the first target state of charge or second target state of charge or discontinue the charging based on the assignment and the at least one determined operating condition.

### BRIEF DESCRIPTION OF DRAWINGS

FIGS. 1-2 are exemplary illustrations of an environment, in accordance with which various embodiments of the present disclosure are implemented;

FIG. 3 is an exemplary block diagram of a charger control system of a charging unit employed in the environment of FIGS. 1-2, in accordance with an embodiment of the present disclosure;

FIG. 4 is an exemplary block diagram of a machine control system of a battery electric machine (BEM) employed in the environment of FIGS. 1-2, in accordance with the embodiment of the present disclosure;

FIG. 5 is an exemplary block diagram of an independent control system of an independent power source employed in the environment of FIGS. 1-2, in accordance with an embodiment of the present disclosure;

FIG. 6 is an exemplary embodiment of a server control system of a server employed in the environment of FIGS. 1-2, in accordance with the embodiment of the present disclosure; and

FIG. 7 is an exemplary method for electrical load management, in accordance with the embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

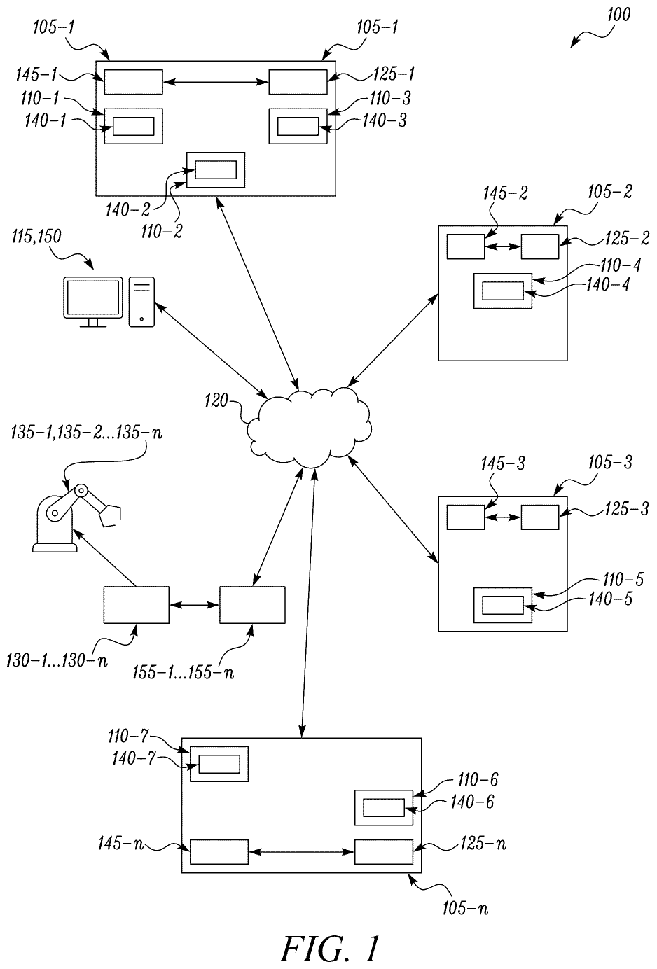

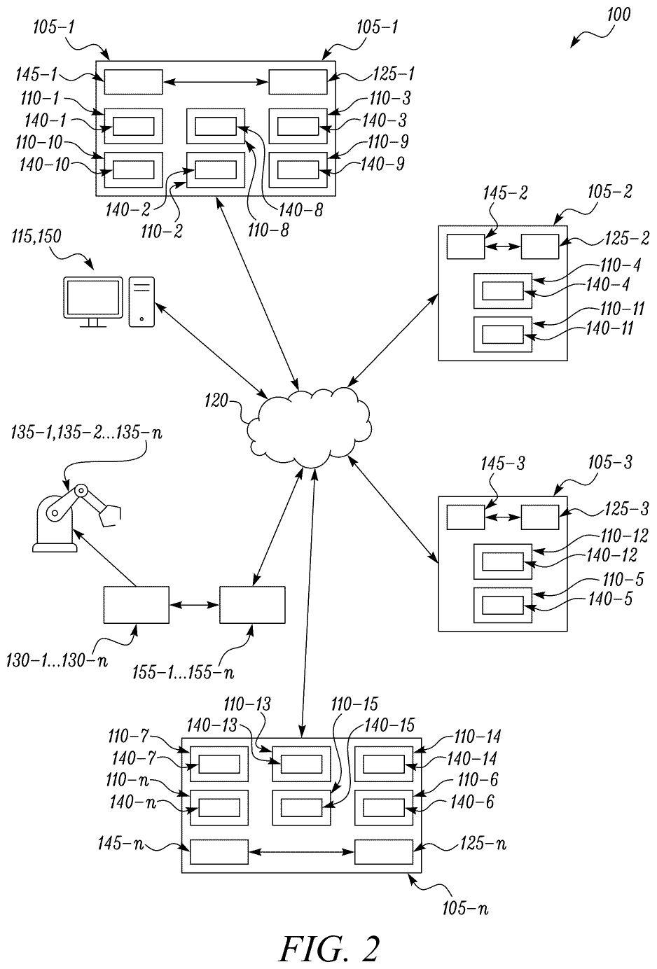

Referring to FIGS. 1-2, an environment 100, herein referred to as, ‘worksite 100’, including at least one charging unit, for example, 105-1 through 105-n, at least one battery electric machine (BEM), for example, 110-1 through 110-n, and a server 115 in communication with each other via a network 120 is disclosed. In embodiments, the worksite 100 corresponds to an electrified worksite including at least one charger power source, for example, 125-1 through 125-n configured to provide electrical power to the charging unit(s), for example, 105-1 through 105-n. In embodiments, the worksite 100 also includes at least one independent power source, for example, 130-1 through 130-n employed at different locations within the worksite 100 to power at least one electrical equipment or machinery, for example, 135-1 through 135-n. It will be apparent to those with ordinary skill in the art that, in embodiments, one or more of the independent power sources, for example, 130-1 through 130-n may also be configured to provide electrical power to the charging unit(s) and/or the at least one BEM, for example, 110-1 through 110-n. In embodiments, the BEMs, for example, 110-1 through 110-n, are configured to operate on electric power derived from respective battery power sources, for example, 140-1 through 140-n provided in the BEMs. The battery power sources, for example, 140-1 are chargeable via at least one charging unit of the charging units, for example, 105-1 through 105-n. In embodiments, the charging unit(s), for example, 105-1 through 105-n include a charger control system, for example, 145-1 through 145-n for electrical load management of the charger power source(s), for example, 125-1 through 125-n, associated with the charging unit(s), for example, 105-1 through 105-n. In embodiments, the server 115 also includes a server control system 150 for electrical load management of the charger power source(s), for example, 125-1 through 125-n, associated with the charging unit(s), for example, 105-1 through 105-n and/or the independent power sources, for example, 130-1 through 130-n employed within the worksite 100. In embodiments, the independent power sources, for example, 130-1 through 130-n include an independent control system, for example, 155-1 through 155-n for electrical load management of the independent power source(s), for example, 130-1 through 130-n. It will be understood by those with ordinary skill in the art that while multiple power sources, for example, 125-1 through 125-n and/or 130-1 through 130-n, are illustrated in FIGS. 1-2, in embodiments, a single power source (not shown) is also configurable to supply electric power to the charging unit(s), for example, 105-1 through 105-n, and/or the electrical equipment or machinery, for example, 135-1 through 135-n respectively.

Examples of the server 115 include, but are not limited to, computers, laptops, mobile devices, handheld devices, personal digital assistants (PDAs), tablet personal computers, digital notebook, wearables, and other electronic devices now known or in future developed. It will be understood by those with ordinary skill in the art that the server 115 may correspond to one or more or a collection of virtual servers, physical servers, remote cloud servers, on-premises cloud servers, and other servers presently known or in future developed. Examples of the BEM(s), for example, 110-1 through 110-n, include, but are not limited to, haul trucks, water trucks, loaders, excavators, shovels, tractors, graders, light vehicles and other service vehicles now known or in future developed. In embodiments, the BEMs, for example, 110-1 through 110-n are autonomous machines or manually controlled machines such as, for example, those operated by an operator. Examples of the network 120 include, but are not limited to, a Local Area Network (LAN), a Wireless Local Area Network (WLAN), a Small Area Network (SAN), a Wi-Fi Direct Network, and a telecommunication network including, but not limited to, a fourth generation (4G) and a fifth generation (5G) cellular network. Examples of the charger power sources, for example, 125-1 through 125-n, and/or the independent power sources, for example, 130-1 through 130-n include, but are not limited to, renewable energy power sources, battery power sources, natural gas generators, hydrogen fuel cells, pumped-storage hydroelectricity and other power sources now known or in future developed.

In embodiments, the electrical load on the charger power sources, for example, 125-1 through 125-n and/or the independent power sources, for example, 130-1 through 130-n vary over different time periods depending on a count of the BEM(s), for example, 110-1 through 110-n and/or the electrical equipment or machinery, for example, 135-1 through 135-n connected to the charger power sources and/or the independent power sources, an amount and/or a rathe of electrical power drawn by the BEM(s) and/or the electrical equipment or machinery at a given point in time. For example, the electrical load on the charger power sources, for example, 125-1 through 125-n is lower when the count of the BEM(s), for example, 110-1 through 110-n connected to the charging unit(s), for example, 105-1 through 105-n is less than a predefined count threshold as shown in FIG. 1. As another example, the electrical load on the charger power sources, for example, 125-1 through 125-n is lower when the amount of and/or the rate of electrical power drawn by the BEM(s), for example, 110-1 through 110-n connected to the charging unit(s), for example, 105-1 through 105-n is less than a predefined threshold. Similarly, the electrical load on the charger power sources, for example, 125-1 through 125-n is higher when the count of the BEM(s), for example, 110-1 through 110-n connected to the charging unit(s), for example, 105-1 through 105-n is greater than the predefined count threshold as shown in FIG. 2. As another example, the electrical load on the charger power sources, for example, 125-1 through 125-n is greater when the amount of and/or the rate of electrical power drawn by the BEM(s), for example, 110-1 through 110-n connected to the charging unit(s), for example, 105-1 through 105-n is greater than a predefined threshold.

In embodiments, the electrical load on the charger power sources, for example, 125-1 through 125-n and/or the independent power sources, for example, 130-1 through 130-n also vary over different time periods based on an availability of power at or the electrical power generated by the charger power sources, for example, 125-1 through 125-n and/or the independent power sources, for example, 130-1 through 130-n. For example, the electrical load on the charger power sources, for example, 125-1 through 125-n increases when an availability of the power is less than a predefined power threshold and the count of the BEM(s), for example, 110-1 through 110-n connected to the charging unit(s), for example, 105-1 through 105-n is greater than the predefined count threshold. Similarly, the electrical load on the charger power sources, for example, 125-1 through 125-n is reduced when the availability of the power is greater than the predefined power threshold and/or the count of the BEM(s), for example, 110-1 through 110-n connected to the charging unit(s), for example, 105-1 through 105-n is lesser than the predefined count threshold.

In embodiments, the charger control system(s), for example, 145-1 through 145-n, and/or the server control system, for example, 150, are configured to determine a current count of the BEMs, for example, 110-1 through 110-n connected to the charging unit(s), for example, 105-1 through 105-n. In embodiments, the charger control system(s), for example, 145-1 through 145-n, and/or the server control system, for example, 150, are configured to determine a projected count of the BEMs, for example, 110-1 through 110-n expected to connected to the charging unit(s), for example, 105-1 through 105-n in an upcoming or a future time period. In embodiments, the independent control system(s), for example, 155-1 through 155-n, and/or the server control system, for example, 150, are also configured to determine a current count of the electrical equipment or machinery, for example, 135-1 through 135-n connected to the independent power sources, for example, 130-1 through 130-n. In embodiments, the independent control system(s), for example, 155-1 through 155-n, and/or the server control system, for example, 150, are also configured to determine a predicted count of the electrical equipment or machinery, for example, 135-1 through 135-n expected to be connected to the independent power sources, for example, 130-1 through 130-n in the upcoming or future time period. In embodiments, the charger control system(s), for example, 145-1 through 145-n, the independent control system(s), for example, 155-1 through 155-n, and/or the server control system, for example, 150 are configured to determine a current and/or projected electrical load on the charger power sources, for example, 125-1 through 125-n at the charging unit(s), for example, 105-1 through 105-n, and/or the independent power sources, for example, 130-1 through 130-n. In embodiments, the charger control system(s), for example, 145-1 through 145-n, the independent control system(s), for example, 155-1 through 155-n, and/or the server control system, for example, 150, are configured to determine a current and/or projected availability of power at the charger power sources, for example, 125-1 through 125-n and/or the independent power sources, for example, 130-1 through 130-n.

In embodiments, the charger control system(s), for example, 145-1 through 145-n, and/or the server control system 150 are configured to assign a first target state of charge or a second target state of charge corresponding to each BEM of the BEM(s), for example, 110-1 through 110-n connected to the charging unit(s), for example, 105-1 through 105-n based on the determined current or projected count of BEM(s), the determined count of the electrical equipment or machinery, the determined current or projected electrical load, and/or the determined current or projected availability of power. In embodiments, the charger control system(s), for example, 145-1 through 145-n, and/or the server control system, for example, 150, are also configured to initiate charging of the at least one connected BEM, for example, 110-1 through 110-n, up to the first target state of charge or the second target state of charge based on the assignment to manage the electrical load on at least one the charger power source, for example, 125-1 through 125-n associated with the at least one charging unit, for example, 105-1 through 105-n respectively.

For purposes of clarity and understanding, different components and respective functions performed by the different components of the charger control system, for example, 145-1 associated with the charging unit, for example, 105-1 for the electrical load management of the charger power source, for example, 125-1 associated with the charging unit 105-1 will be discussed hereinafter. However, it will be understood by those with ordinary skill in the art that the remaining charger control systems, for example, 145-2 through 145-n include similar components as the charger control system, for example, 145-1 and are configured to perform similar functions as the functions performed by the components of the charger control system, for example, 145-1 respectively.

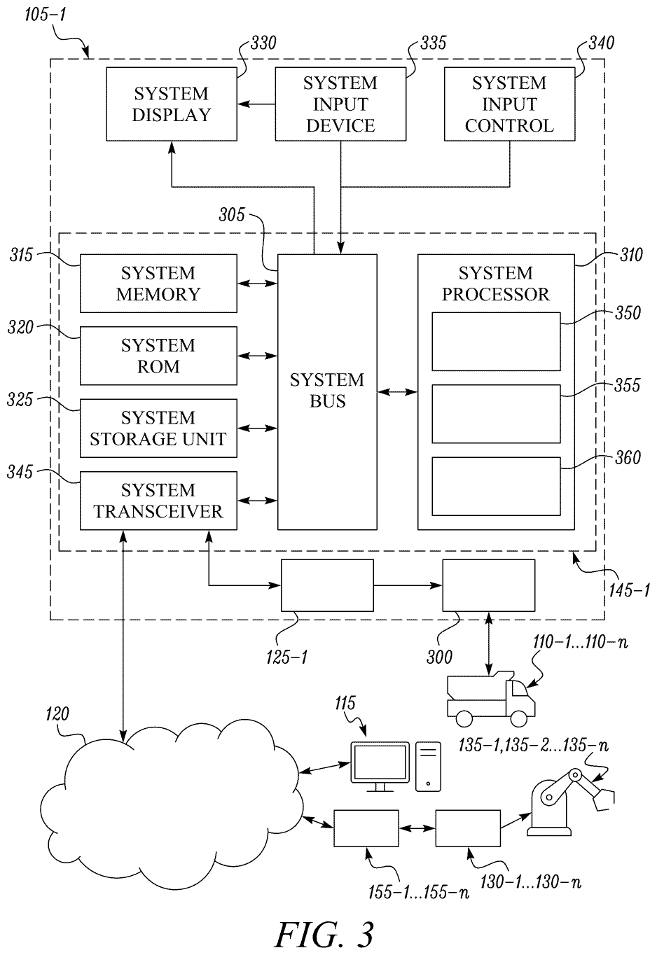

Referring to FIG. 3, an exemplary block diagram of the charging unit 105-1 of FIG. 1 employed within the worksite 100 of FIGS. 1-2 for charging the BEM(s), for example, 110-1 through 110-n (see FIG. 1) via the charger power source 125-1 is disclosed. In embodiments, the charging unit 105-1 includes the charger power source 125-1 (see FIG. 1), a charger power outlet 300, and the charger control system 145-1 for electrical load management of the charger power source 125-1 associated with the charging unit 105-1. It will be understood by those with ordinary skill in the art that, in embodiments, the charger power source 125-1 may be external to the charging unit 105-1. It will also be understood by those with ordinary skill in the art that, in embodiments, multiple power sources, for example, 125-1 through 125-n, and/or the independent power sources, for example, 130-1 through 130-n or a single power source common to the charging unit 105-1 and the other charging units, for example, 105-2 through 105-n may also be configured to provide electrical power to the charging unit 105-1. The charger power source(s), for example, 125-1...125-n, and/or the independent power source(s), for example, 130-1...130-n configured to provide the electrical power to the charging unit 105-1 is herein referred to as the “power source 125, 130”. It may also be understood by those with ordinary skill in the art that the charger control system 145-1 may be external to the charging unit 105-1 and/or common to one or more of the remaining charging units, for example, 105-2 through 105-n. Further, it may also be understood by those with ordinary skill in the art that the charger control system 145-1 associated with the charging unit 105-1 and the independent control system, for example, 155-1 associated with the independent power source, for example, 130-1 may be the same for instances when the power source 125, 130 is common to the charging unit 105-1 and one or more of remaining charging units, for example, 105-2 through 105-n.

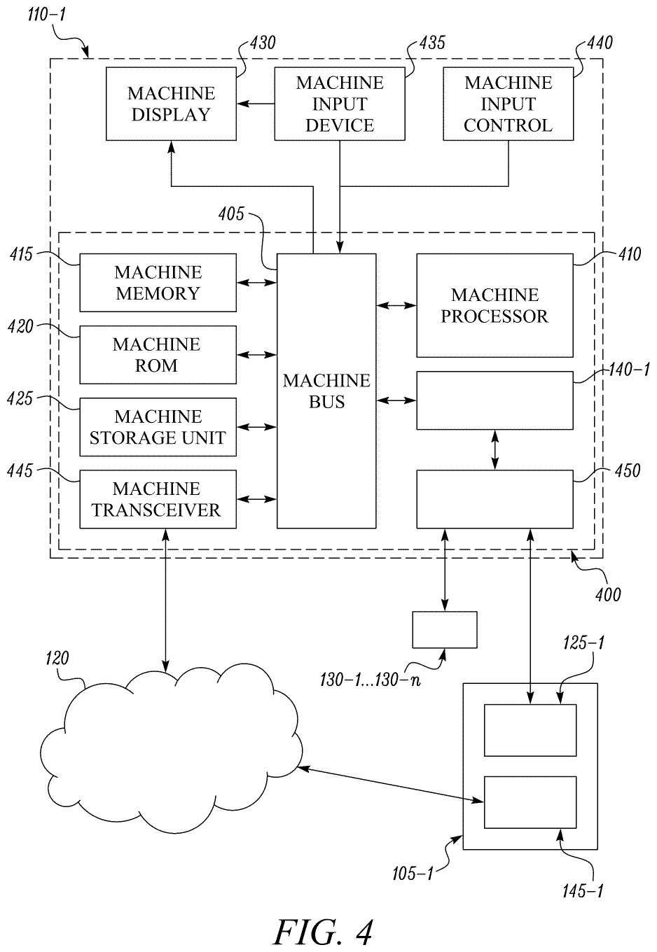

In embodiments, the charger power outlet 300 corresponds to a charger connection means including, but not limited to, a charging cable, a charging port, or a charging pad configured for connection with the BEM(s), for example, 110-1 through 110-n, via corresponding machine connection means 450 (see FIG. 4) including, but not limited to, a machine charging cable, a machine charging port, or a machine charging surface provided in the BEM(s) for wired or wireless charging of the BEM(s) upon the connection with the charger power outlet 300. In some embodiments, the charger connection means may be autonomous and the autonomous charger connection means may include, but is not limited to, a robotic charging arm configured for connection with the BEMs, for example, 110-1 through 110-n via the corresponding machine connection means 450 provided in the BEM(s). The charger control system 145-1 includes a system bus 305 or other communication mechanism for communicating information, and a system processor 310 coupled with the system bus 305 for processing information. The charger control system 145-1 also includes a system memory 315, such as a random-access memory (RAM) or other dynamic storage device, coupled to the system bus 305 for storing information and instructions to be executed by the system processor 310. The system memory 315 can be used for storing temporary variables or other intermediate information during execution of instructions to be executed by the system processor 310. The charger control system 145-1 further includes a system read-only-memory (ROM) 320 or other static storage device coupled to system bus 305 for storing static information and instructions for the system processor 310.

A system storage unit 325, such as, but not limited to, a magnetic disk, an optical disk, or a solid-state disk, is provided and coupled to the system bus 305 to store information. Examples of the information include, but are not limited to, a machine identification associated with each BEM, a current and/or project count of the BEM(s) connected or expected to be connected to the charging unit 105-1 via, for example, the charger power outlet 300 for charging, a current and/or projected rate of power generation by the charger power source 125-1, at least one task assigned to the BEM(s), for example, 110-1 through 110-n respectively, a count of the at least one task assigned to the BEM(s), and/or an historical electrical load on the charger power source 125-1 associated with the charging unit 105-1 recorded over a discrete historical time period(s) or time duration(s). In embodiments, the system storage unit 325 may also store one or more machine learning, artificial intelligence, logical, and/or conditional modules, algorithms, and/or models. It may be understood that the information stored in the system storage unit 325 may be accessed by the system processor 310 via the system memory 315 to perform one or more functions.

The charger control system 145-1 can be coupled via the system bus 305 to a system display 330, such as a light emitting diode (LED) and a liquid crystal display (LCD) for displaying information to an operator of the charger control system 145-1. A system input device 335 is coupled to system bus 305 for communicating information and command selections to the system processor 310. The system input device 335 may be included in the system display 330, for example a touch screen that facilitates detection of multi-touch inputs from the user via the system display 330. The system input device 335 may also correspond to peripheral input devices that may be paired with the charger control system 145-1 via Bluetooth, Wi-Fi, Wi-Fi direct, or as a hardware connection such a USB peripheral to the charger control system 145-1. Examples of the peripheral input devices include, but are not limited to, a joystick, a gamepad, a keyboard, a mouse, a gesture-controlled device, or a wearable device such as, for example, a smart watch. In embodiments, the system input device 335 may also correspond to a microphone (not shown) provided in the charger control system 145-1 that is configured to received audio inputs or instructions from the operator(s) of the charging unit 105-1. In embodiments, the system input device 335 may also include alphanumeric and other keys. Another type of user input device is a system input control 340, such as a mouse, a trackball, or cursor direction keys for communicating direction information and command selections to the system processor 310 and for controlling cursor movement on the system display 330.

Various embodiments are related to the use of charger control system 145-1 for implementing the techniques described herein. In one embodiment, the techniques are performed by the charger control system 145-1 in response to the system processor 310 executing instructions included in the system memory 315. Such instructions can be read into the system memory 315 from another machine-readable medium, such as the system storage unit 325. Execution of the instructions included in the system memory 315 causes the system processor 310 to perform the process steps described herein.

The term “machine-readable medium” as used herein refers to any medium that participates in providing data that causes a machine to operate in a specific fashion. In an embodiment implemented using the charger control system 145-1, various machine-readable medium is involved, for example, in providing instructions to the system processor 310 for execution. The machine-readable medium can be a storage media. Storage media includes both non-volatile media and volatile media. Non-volatile media includes, for example, optical or magnetic disks, such as system storage unit 325. Volatile media includes dynamic memory, such as the system memory 315. All such media must be tangible to enable the instructions carried by the media to be detected by a physical mechanism that reads the instructions into a machine. Common forms of machine-readable medium include, for example, a floppy disk, a flexible disk, hard disk, magnetic tape, a solid-state disk, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that include the system bus 305. Transmission media can also take the form of acoustic or light waves, such as those generated during radio-wave and infra-red data communications. Examples of machine-readable medium may include, but are not limited, to a carrier wave as described hereinafter or any other medium from which the charger control system 145-1 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the charger control system 145-1 can receive the data on the telephone line and use an infra-red transmitter to convert the data to an infra-red signal. An infra-red detector can receive the data carried in the infra-red signal and appropriate circuitry can place the data on the system bus 305. The system bus 305 carries the data to the system memory 315, from which the system processor 310 retrieves and executes the instructions. The instructions received by the system memory 315 can optionally be stored in the system storage unit 325 either before or after execution by the system processor 310.

The charger control system 145-1 also includes a system transceiver 345 coupled to the system bus 305. The system transceiver 345 provides a two-way data communication coupling with the server 115 and/or the BEM(s), for example, 110-1 through 110-n. For example, the system transceiver 345 can be an integrated service digital network (ISDN) card or a modem to provide a data communication connection to a corresponding type of telephone line. As another example, the system transceiver 345 can be a local area network (LAN) card to provide a data communication connection to a compatible LAN. Wireless links can also be implemented. In any such implementation, the system transceiver 345 sends and receives radio, electrical, electromagnetic, or optical signals that carry digital data streams representing various types of information.

In embodiments, the system processor 310 may be capable of executing the computer instructions stored in the system memory 315 to perform one or more functions. In embodiments, the system processor 310 may include one or more modules 350-360 to perform the one or more functions. For example, the system processor 310 may include a determination module 350, an assignment module 355, and a charging module 360. It may be understood that the modules 350-360 may correspond to and/or include hardware and/or software components respectively and may be configured to perform respective functions. It may also be understood that, in embodiments, the modules 350-360 may implement one or more machine learning, artificial intelligence, logical, and/or conditional operations, modules, algorithms, and/or models stored in the system storage unit 325 to perform the respective functions.

The determination module 350 is configured to determine at least one operating condition associated with the charging unit 105-1. In embodiments, the at least one operating condition includes, but is not limited to, a current electrical load on the power source 125, 130, a current availability of electrical power from the power source 125, 130, a current time or time period of operation of the charging unit 105-1, and/or a current state of charge of the at least one BEM, for example, 110-1 through 110-n in communication with the system processor 310 and connected to the charging unit 105-1 via, for example, the charger power outlet 300. In embodiments, the at least one operating condition also includes, but is not limited to, a projected electrical load on the power source 125, 130 over a predefined time period or at the different future or upcoming time periods, and/or a projected availability of the electrical power from the power source 125, 130 over the predefined time period or the future or upcoming time periods. In embodiments, the predefined time period and/or the future or upcoming time period(s) corresponds to an upcoming hour or a set of hours after the current time for example, the current hour or current time period including, for example, the current predefined set of hours.

In embodiments, the determination module 350 is configured to determine the current electrical load on the power source 125, 130 by determining a current count of the at least one BEM, for example, 110-1 through 110-n, connected to the charging unit 105-1 via the charger power outlet 300. In embodiments, the determination module 350 is also configured to determine the current electrical load on the power source 125, 130 by determining an amount and/or a rate of electrical power drawn by the BEM(s), for example, 110-1 through 110-n and/or the electrical equipment or machinery connected to the power source 125, 130. In embodiments, the determination module 350 is also configured to determine the projected electrical load by determining at least one historical electrical load on the power source 125, 130 recorded over the discrete historical time period or time durations, a projected count of the at least one BEM, for example, 110-1 through 110-n expected to be connected to the charging unit 105-1 over the predefined time period or at the future or upcoming time period(s), and/or a projected count of at least one electrical equipment or machinery, for example, 135-1 through 135n expected to be connected to the power source 125, 130 in addition to the at least one BEM, for example, 110-1 through 110-n. In embodiments, the determination module 350 is configured to determine the projected count of the at least one BEM, for example, 110-1 through 110-n expected to be connected to the charging unit 105-1 based on historical data associated with the count of the at least one BEM connected to the charging unit 105-1 over the discrete historical time period or time durations, at least one task assigned to the at least one BEM, for example, 110-1, the determined current state of charge of the at least one BEM, an estimated state of charge of the at least one BEM after completion of the at least one assigned task, and/or an estimated time for completion of the at least one assigned task by the at least one BEM, for example, 110-1.

In embodiments, the determination module 350 is configured to determine the current availability of power by determining a current weather condition or a weather condition during the current time period, a current count of the at least one BEM, for example, 110-1 through 110-n connected to the charging unit 105-1, and/or a current count of at least one electrical equipment or machinery, for example, 135-1 through 135-n connected to the power source 125, 130 in addition to the at least one BEM. In embodiments, the determination module 350 is configured to determine the current availability of power by determining a current rate of power generation of the power source 125, 130 based on, for example, the determined current weather. Similarly, the determination module 350 is configured to determine the projected availability of the electrical power by determining a predicted weather condition over the predefined time period or in the upcoming or future time period(s), a projected count of the at least one BEM, for example, 110-1 through 110-n, expected to be connected to the charging unit 105-1 over the predefined time period or in the upcoming or future time period(s), and/or a projected count of at least one electrical equipment or machinery expected to be connected to the power source 125, 130 in addition to the at least one BEM, for example, 110-1 through 110-n. In embodiments, the determination module 350 is configured to determine the projected availability of power by determining a projected rate of power generation of the power source 125, 130 at the predefined time period or in upcoming or future time period(s) based on, for example, the predicted weather. For example, the determination module 350 is configured to determine the current weather condition to be cloudy and determine that the current availability of power at the power source 125, 130 that corresponds to a renewable power source such as, for example, a solar power source, to be limited as a result. Similarly, the determination module 350 is configured to determine the predicted weather condition to be sunny for the upcoming or future time period and determine that the projected availability of power at the power source 125, 130 corresponding to, for example, the solar power source to be higher than the determined current availability of power.

Referring to FIG. 4, in embodiments, each BEM of the at least one BEM, for example, 110-1 through 110-n, may include a machine system 400 and a machine connection means 450 configured for connection with the charger power outlet, for example, 300 (see FIG. 3) of the charging unit, for example, 105-1 to charge the battery/battery pack of each BEM via the charger power source, for example, 125-1. In embodiments, the machine connection means 450 configured for direct connection with the independent power source, for example, 130-1. In embodiments, the machine system 400 is similar to the charger control system, for example, 145-1 associated with the charging unit, for example, 105-1 and include machine components 405-445 similar to the system components 305-345 of the charger control system, for example, 145-1. For example, the machine system 400 may also include a machine bus 405, a machine processor 410, a machine memory 415, a machine ROM 420, a machine storage unit 425, a machine display 430, a machine input device(s) 435, a machine input control 440, and a machine transceiver 445. In embodiments, the machine processor 410 of the machine system 400 may be configured to receive the instructions from the charger control system, for example, 145-1, via the network 120 and the machine transceiver 445, and perform one or more functions including, but not limited to, providing at least one input associated with the corresponding BEM, for example, 110-1 upon wired connection of the machine connection means 450 with the charger power outlet, for example, 300 of the charging unit, for example, 105-1 via, or wireless connection via the network 120. Examples of the at least one input include, but are not limited to, a machine identification associated with the corresponding BEM, at least one task assigned to the corresponding BEM, and/or the current state of charge of the BEM.

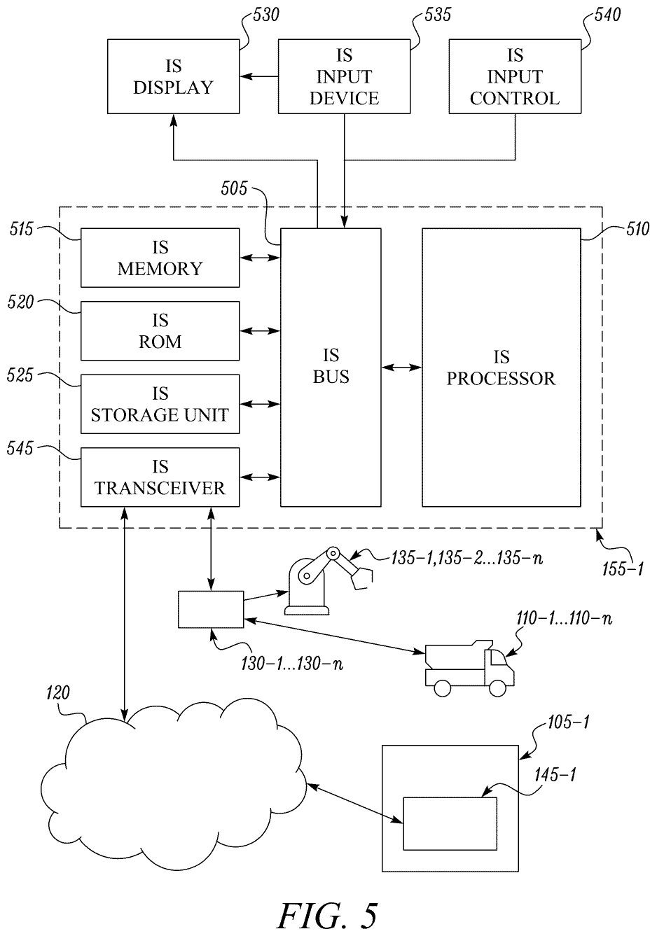

Referring to FIG. 5, an exemplary block diagram of the independent control system, for example, 155-1 in communication with the independent power source, for example, 130-1 via the network 120 is disclosed. In embodiments, the independent control system, for example, 155-1 similar to the charger control system, for example, 145-1 associated with the charging unit, for example, 105-1 and include independent system components 505-545 similar to the system components 305-345 of the charger control system, for example, 145-1. For example, the independent control system 155-1 may also include an independent system (IS) bus 505, an IS processor 510, an IS memory 515, an IS ROM 520, an IS storage unit 525, an IS display 530, an IS input device(s) 535, an IS input control 540, and an independent system transceiver 545. In embodiments, the independent system processor 510 of the independent control system, for example, 155-1 may be configured to receive the instructions from the charger control system, for example, 145-1, via the network 120 and the independent system transceiver 545, and perform one or more functions including, but not limited to, providing at least one input associated with the independent power source, for example, 130-1. Examples of the at least one input include, but are not limited to, a current and/or projected load on the at least one independent power source, for example, 130-1, a current or projected availability of electrical power at the at least one independent power source, for example, 130-1, a current or projected count of the at least one BEM, for example, 110-1 through 110-n and/or at least one electrical machinery, for example, 135-1 through 135-n connected or expected to be connected to the at least one independent power source, for example, 130-1, and/or a current and/or projected rate of power generation at the predefined time period or in the upcoming or future time period(s).

Referring again to FIG. 3, the assignment module 355 is configured to assign a first target state of charge or a second target state of charge corresponding to the at least one connected BEM based on the at least one determined operating condition by the determination module 350. In embodiments, the second target state of charge is greater than the first target state of charge by at least a predefined threshold. For example, the second target state of charge is greater than the first target state of charge by at least 10 percent. In embodiments, the first target state of charge is greater than a first charge threshold and the second target state of charge is less than a second charge threshold. For example, the first target state of charge is greater than the first charge threshold of, for example, 10 percent of the maximum battery capacity of the at least one BEM, for example, 110-1 and the second target state of charge is less than the second charge threshold of, for example, 90 percent of the maximum battery capacity of the at least one BEM. It will be understood by those with ordinary skill in the art the battery capacity of the at least one BEM, for example, 110-1 corresponds to the battery capacity of a battery or a battery pack provided in the at least one BEM. In embodiments, the first target state of charge and/or the second target state of charge is within a predefined range of state of charge. In embodiments, the first target state of charge and/or the second target state of charge is within a linear charging range of the battery or battery pack provided in the at least one BEM. The linear charging range of the battery refers to a range within which the battery draws a relatively constant current while charging, such that, an increase in the state of charge of the battery is substantially linear with respect to the electrical current drawn from the charging unit 105-1 and a time taken to charge the battery between different states of charge in the linear charging range is substantially the same. For example, in the linear charging range, a time taken to charge the battery from 20 percent of a maximum battery capacity of the at least one BEM, for example, 110-1 to 40 percent of the maximum battery capacity and/or a time taken to charge the battery from 50 percent of a maximum battery capacity of the at least one BEM, for example, 110-1 to 70 percent of the maximum battery capacity may be substantially the same. In embodiments, the first target state of charge is within a lower range of state of charge in the predefined range of state of charge in comparison to the second target state of charge. For example, the first target state of charge is within, for example, 10 to 20 percent of the maximum battery capacity of the BEM(s) and the second target state of charge is within, for example, 60 to 80 percent of the maximum battery capacity of the BEM(s). In embodiments, the first target state of charge and the second target state of charge are predefined or vary based on the determined operating conditions including, but not limited to, the determined current and/or projected count of the connected BEM(s), the determined current and/or projected count of the connected electrical equipment or machinery, the determined current and/or projected electrical load on the power source 125, 130, and/or the determined current and/or projected availability of power at the power source 125, 130.

In embodiments, the assignment module 355 is configured to assign the first target state of charge when the determined current and/or projected count is greater than a predefined count threshold and/or the determined current and/or projected availability of power is less than a first predefined power threshold. In embodiments, the predefined count threshold may be based on a count of charging points or connections provided at the charging unit 105-1. For example, the predefined count threshold may correspond to 6 BEMs or greater than or equal to 5 BEMs corresponding to the charging unit 105-1 as shown in FIG. 2. In embodiments, the assignment module 355 is also configured to assign the first target state of charge when the current state of charge of the at least one BEM, for example, 110-1 is greater than or equal to the first charge threshold. In embodiments, the assignment module 355 is also configured to assign the first target state of charge when the determined current count of the at least one BEM, for example, 110-1 through 110-n connected to the charging unit 105-1 via the charger power outlet 300 is greater than the determined projected count of the at least one BEM at an upcoming or future time period or time duration. In embodiments, the assignment module 355 is also configured to assign the first target state of charge when the determined current availability of power is less than the determined projected availability of power at an upcoming or future time period or time duration.

In embodiments, the assignment module 355 is configured to assign the second target state of charge when the determined current and/or projected count is less than the predefined count threshold and/or the determined current and/or projected availability of power is greater than the predefined power threshold. For example, the assignment module 355 is configured to assign the second target state of charge when the predefined count threshold corresponds to less than 5 BEMs corresponding to the charging unit 105-1 as shown in FIG. 2. In embodiments, the predefined count threshold is same or different for charging unit 105-1 and the remaining charging units, for example, 105-2 through 105-n. In embodiments, the assignment module 355 is also configured to assign the second target state of charge when the current state of charge of the at least one BEM, for example, 110-1 is less than or equal to the second charge threshold. In embodiments, the assignment module 355 is also configured to assign the second target state of charge when the determined current count of the at least one connected BEM, for example, 110-1 through 110-n is less than the determined projected count of the at least one BEM at an upcoming or future time period or time duration. In embodiments, the assignment module 355 is also configured to assign the second target state of charge when the determined current availability of power is greater than the determined projected availability of power at an upcoming or future time period or time duration.

In embodiments, the assignment module 355 is configured to determine and assign at least one task to be performed at a given point in time or within a given time duration by the at least one BEM, for example, 110-1 through 110-n after the charging based on the assigned first target state of charge or the assigned second target state of charge. In embodiments, the assignment module 355 is also configured to determine and/or assign at least one task to the at least one BEM, for example 110-1 through 110-n prior to charging the at least one BEM. In such embodiments, the assignment module 355 is configured to assign the first target state of charge or the second target state of charge based on the at least one assigned task and/or the determined operating conditions. In such embodiments, the assignment module 355 is configured to determine an estimated depth of discharge of the at least one BEM, for example, 110-1, after completion of the at least one assigned task. In such embodiments, the assignment module 355 is configured to assign the first target state of charge corresponding to the at least one BEM, for example, 110-1 based on the determined estimated depth of discharge such that the at least one BEM is capable of completing the at least one assigned task and a state of charge of the at least one BEM after completion of the at least one assigned task is greater than or equal to at least 10 percent of the maximum battery capacity of the at least one BEM. In such embodiments, the assignment module 355 is also configured to determine an estimated increase in percentage of a state of charge of the at least one BEM, for example, 110-1 via regenerative braking based on the at least one assigned task. In such embodiments, the assignment module 355 is configured to assign the second target state of charge based on the determined estimated increase in percentage such that the state of charge of the at least one BEM is less than or equal to 90 percent of the maximum battery capacity of the at least one BEM.

In embodiments, the assignment module 355 is also configured to assign a third target battery charge corresponding to the at least one BEM, for example, 110-1 when the determined current electrical load is greater than or equal to the predefined load threshold and the determined current state of charge of the at least one BEM, for example, 110-1 is less than the first charge threshold. For example, the assignment module 355 is configured to assign a third target battery charge corresponding to the BEM, for example, 110-1 when the determined current electrical load is greater than or equal to the predefined load threshold and the determined current state of charge of the BEM 110-1 is less than 10 percent of the maximum battery capacity of the BEM 110-1. In embodiments, the third target battery state of charge is different from the first target state of charge and/or the second target battery state of charge. In embodiments, the third target battery state of charge is same as the second target battery state of charge. In embodiments, the the assignment module 355 is also configured to assign the third target battery charge based on the at least one task assigned to the at least one BEM, for example, 110-1 prior to the charging of the at least one BEM. In embodiments, the assignment module 355 is also configured to modify the assignment of the at least one BEM, for example, 110-1 from the previously assigned first target state of charge or the second target state of charge to the third target state of charge based on the at least one assigned task, the determined current electrical load, the determined current state of charge of the at least one BEM, and/or one or more of the remaining determined operating conditions.

The charging module 360 is configured to initiate charging of the at least one BEM, for example, 110-1, via the power source 125, 130 and the charger power outlet 300, up to the first target state of charge, the second target state of charge, or the third target state of charge based on the assignment, the at least one determined operating condition, and/or the at least one task assigned to the at least one BEM. In embodiments, the charging module 360 is configured to initiate the charging of the at least one BEM, for example, 110-1 up to the first target state of charge for a first predefined time period and/or until the determined current electrical load is greater than the predefined load threshold and/or until the determined current count is greater than or equal to the predefined count threshold. In embodiments, the charging module 360 is configured to initiate the charging of the at least one BEM, for example, 110-1 from the first target state of charge to the second target state of charge after the first predefined time period and/or when the determined current electrical load is less than the predefined load threshold and/or when the determined current count of the at least one BEM, for example, 110-1 through is less than the predefined count threshold. For example, the charging module 360 is configured to initiate the charging of the at least one BEM from the first target state of charge to the second target state of charge when the determined current count of the at least one BEM, for example, 110-1 through 110-3 (as shown in FIG. 1) is less than the predefined count threshold corresponding to, for example, the count of the charging points or connections, or less than, for example, 5 or 6 BEM(s). Similarly, in embodiments, the charging module 360 is configured to initiate the charging of the at least one BEM, for example, 110-1 up to the second target state of charge for a second predefined time period and/or until the determined current electrical load is less that the predefined load threshold and/or until the determined current count is less than the predefined count threshold. In embodiments, the charging module 360 is configured to initiate the charging of the at least one BEM, for example, 110-1 from the second target state of charge to first target state of charge after the second predefined time period and/or when the determined current electrical load is greater that the predefined load threshold and/or when the determined current count is greater than or equal to the predefined count threshold. For example, the charging module 360 is configured to initiate the charging of the at least one BEM from the second target state of charge to the first target state of charge when the determined current count of the at least one BEM, for example, 110-1 through 110-6 (as shown in FIG. 2) is greater or equal to, for example, the count of the charging points or connections, or greater than or equal to, for example, 6 BEM(s).

In embodiments, the charging module 360 is also configured to discontinue charging of the at least one BEM, for example, 110-1 based on the assignment. In embodiments, the charging module 360 is configured to discontinue charging of the at least one BEM, for example, 110-1 when the determined state of charge of the at least one BEM, for example, 110-1 by the determination module 350 is greater than or equal to the assigned first target state of charge or the assigned second target state of charge. For example, the charging module 360 is configured to discontinue charging of the BEM, for example, 110-1 when the determined state of charge of the BEM 110-1 by the determination module 350 is greater than or equal to the assigned second target state of charge of 80 percent of the maximum battery capacity of the BEM 110-1. In embodiments, the charging module 360 is also configured to provide a first indication of the discontinued charging, a second indication to disconnect the at least one BEM, for example, 110-1 from the charging unit 105-1, and/or a third indication of a completion of the charging up to the first target state of charge or the second target state of charge to the at least one BEM via the system transceiver 345. In embodiments, the charging module 360 is also configured to provide the first, second, and/or third indication to the at least one BEM, for example, 110-1 via visual or auditory means including, but not limited to, the machine display 430 (see FIG. 4) and a machine alert/alarm system (not shown) provided in the at least one BEM. In embodiments, the charging module 360 is also configured to provide a fourth indication of the at least one task assigned to the at least one BEM, for example, 110-1 based on the assignment of the first target state of charge or the second target state of charge by the assignment module 355 via the system transceiver 345 and/or the visual or auditory means provided in the at least one BEM. In embodiments, the machine processor 410 (see FIG. 4) of the at least one BEM, for example, 110-1 is configured to receive the first, second, third, and/or fourth indication from the charging unit 105-1 via the machine transceiver 445 (see FIG. 4) and provide the indication via the visual and/or auditory means.

Referring again to FIG. 5, it will be understood by those with ordinary skill in the art that the independent system components 505-545 of the independent control system, for example, 155-1 through 155-n (see FIG. 1) associated with a corresponding independent power source, for example, 130-1 through 130-n (see FIG. 1 may also be configured to perform similar functions as the system components 305-345 (see FIG. 3) of the charger control system, for example, 145-1 of the charging unit, for example, 105-1. For example, the independent control system, for example, 155-1, may also be configured to determine the at least one operating condition associated with the corresponding independent power source, for example, 130-1, assign the first, second, or third target state of charge to the at least one electrical equipment or machinery, for example, 135-1 through 135-n connected to the corresponding independent power source, for example, 130-1 and/or initiate charging or supply of electrical power or discontinue charging or supply of the electrical power to the at least one electrical equipment or machinery, for example, 135-1 through 135-n based on the assignment and/or the at least one determined operation condition of the corresponding independent power source, for example, 130-1.

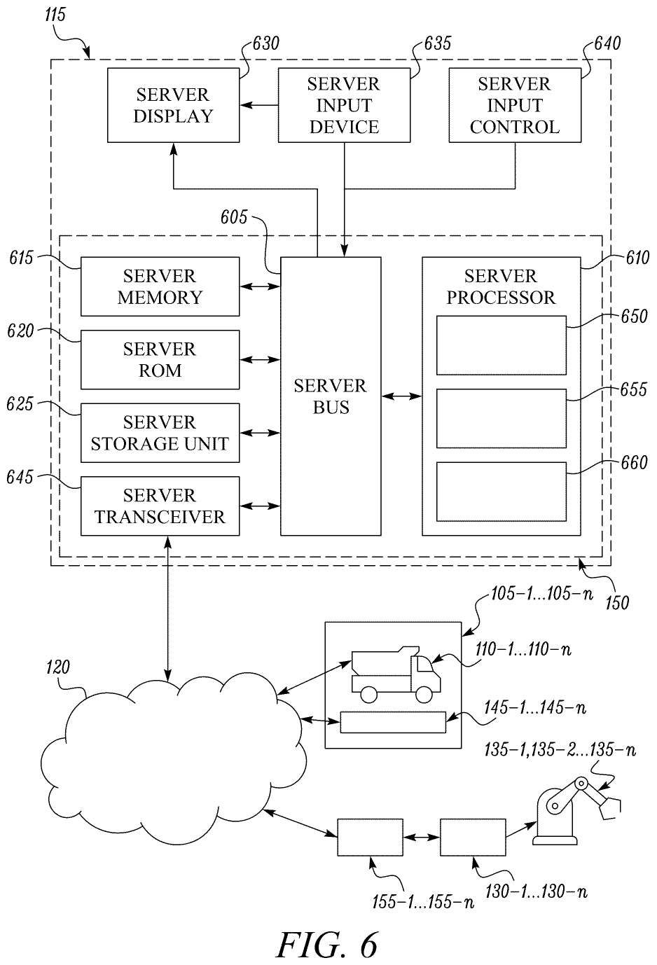

Referring to FIG. 6, the server 115 employed within the worksite 100 of FIGS. 1-2 and in communication with at least one charging unit, for example, 105-1 through 105-n and the at least one BEM, for example, 110-1 through 110-n is disclosed. In embodiments, the server 115 includes the server control system 150 for electrical load management of at least one charging unit, for example, 105-1 through 105-n and/or the at least one independent power source, for example, 130-1 through 130-n. The server control system 150 includes server components 605-645 similar to the system components 305-345 (see FIG. 3) of the charger control system 145-1 of the charging unit, for example, 105-1 respectively. For example, the server control system 150 includes a server bus 605, a server processor 610, a server memory 615, a server ROM 620, a server storage unit 625, a server display 630, a server input device(s) 635, a server input control 640, and a server transceiver 645. In embodiments, the server processor 610 includes one or more server modules, for example, 650-660 configured to perform one or more similar functions as the system modules 350-360 (see FIG. 3) of the charger control system, for example, 145-1.

For example, the server determination module 650 is configured to determine at least one operating condition associated with the at least one charging unit, for example, 105-1, or each charging unit of the plurality of charging units, for example, 105-1 through 105-n. In embodiments, the at least one operating condition includes a cumulative current electrical load on the power source 125, 130 associated with at least one charging unit, for example, 105-1 and/or each charging unit of the plurality of charging units, for example, 105-1 through 105-n. In embodiments, the at least one operating condition also includes a cumulative current count of the at least one BEM, for example, 110-1 through 110-n connected to the at least one on charging unit, for example, 105-1 through 105-n, a cumulative projected count of the at least one BEM expected to be connected to the at least one on charging unit, a current state of charge of the at least one connected BEM, and/or a cumulative projected electric load on the at least one charging unit. In embodiments, the at least one operating condition also includes a cumulative current and/or projected power availability at the at least one power source, for example, 125-1 through 125-n (see FIGS. 1-2) and/or 130-1 through 130-n.

In embodiments, the server determination module 650 is configured to receive the current electrical load on the power source 125, 130 and the current count of the at least one BEM, for example, 110-1 through 110-n connected to each charging unit, for example, 105-1 from the corresponding charging unit, for example, 105-1 via the server transceiver 645. It will be understood by those with ordinary skill in the art that the at least one charging unit, for example, 105-1 is configured to provide the current electrical load on the power source 125, 130 and the current count of the at least one connected BEM to the server control system 150 of the server 115 via the system transceiver 345 (see FIG. 3) of the charger control system, for example, 145-1, and the network 120. In embodiments, the server determination module 650 is also configured to determine the current count of the at least one BEM, for example, 110-1 through 110-n connected to each charging unit, for example, 105-1 based on at least one input received from the at least one BEM, for example, 110-1 via the server transceiver 645 and the network 120. In embodiments, the at least one input includes a location information associated with the at least one BEM, for example, 110-1. It will be understood by those with ordinary skill in the art that the at least one BEM, for example, 110-1 is configured to provide the at least input to the server control system 150 of the server 115 via the machine transceiver 445 (see FIG. 4) and the network 120. In embodiments, server determination module 650 is also configured to determine the cumulative current electrical load on the power source 125, 130 by determining a total amount and/or a rate of electrical power drawn by the BEM(s), for example, 110-1 through 110-n and/or the electrical equipment or machinery connected to the power source 125, 130. In embodiments, the server determination module 650 is configured to determine the projected count of the at least one BEM, for example, 110-1 through 110-n expected to be connected to each charging unit, for example, 105-1 through 105-n based on the historical data, the at least one task assigned to the at least one BEM, for example, 110-1, the determined current state of charge of the at least one connected BEM, the estimated state of charge of the at least one BEM after completion of the at least one assigned task, and/or the estimated time for completion of the at least one assigned task similar to the determination module 350 (see FIG. 3) of the charger control system, for example, 145-1 of the charging unit, for example, 105-1.

In embodiments, the server determination module 650 is configured to determine the cumulative current electrical load by determining the current electrical load on the power source 125, 130 associated with at least one charging unit, for example, 105-1 or each charging unit of the plurality of charging units, for example, 105-1 through 105-n respectively. In embodiments, the server determination module 650 is configured to determine the current electrical load by determining a current count of the at least one BEM, for example, 110-1 through 110-n, connected to each charging units, for example, 105-1. In embodiments, the server determination module 650 is configured to determine the cumulative projected electrical load by the determining the projected electrical load of the power source 125, 130 associated with at least one charging unit, for example, 105-1 or each charging unit of the plurality of charging units, for example, 105-1 through 105-n respectively. In embodiments, server determination module 650 is configured to determine the projected electrical load by determining at least one historical electrical load on the power source 125, 130 recorded over a discrete historical time period or time durations respectively, a projected count of the at least one BEM, for example, 110-1 through 110-n expected to be connected to the each charging unit over the predefined time period or at the future or upcoming time period(s) respectively, and/or a current and/or a projected count of the at least one electrical equipment or machinery, for example, 135-1 through 135n expected to be connected to the power source 125, 130 respectively. In embodiments, the server determination module 650 is configured to determine the projected count of the at least one BEM, for example, 110-1 through 110-n expected to be connected to the charging unit 105-1 based on historical data associated with the count of the at least one BEM connected to the charging unit 105-1 over the discrete historical time period or time durations, at least one task assigned to the at least one BEM, for example, 110-1, the determined current state of charge of the at least one BEM, the estimated state of charge of the at least one BEM after completion of the at least one assigned task, and/or the estimated time for completion of the at least one assigned task by the at least one BEM, for example, 110-1.

In embodiments, the server determination module 650 is also to determine the current availability of power by determining a current weather condition or a weather condition during the current time period, the cumulative current count of the at least one BEM connected to the one or more charging units, for example, 105-1 through 105-n, and/or the cumulative current count of the at least one electrical equipment or machinery, for example, 135-1 through 135-n (see FIGS. 1-2) connected to the at least one power source, for example, 125-1 through 125-n (see FIGS. 1-2) and/or 130-1 through 130-n respectively. In embodiments, the server determination module 650 is configured to determine the current availability of power by determining a current rate of power generation of the at least one power source, for example, 125-1 through 125-n (see FIGS. 1-2) and/or 130-1 through 130-n respectively based on, for example, the determined current weather. Similarly, the server determination module 650 is configured to determine the projected availability of the electrical power by determining a predicted weather condition over the predefined time period or in the upcoming or future time period(s), the projected count of the at least one BEM, for example, 110-1 through 110-n, expected to be connected to each charging unit, for example, 105-1 over the predefined time period or in the upcoming or future time period(s), and/or the projected count of at least one electrical equipment or machinery expected to be connected to the at least one power source, for example, 125-1 through 125-n (see FIGS. 1-2) and/or 130-1 through 130-n respectively. In embodiments, the server determination module 650 is configured to determine the projected availability of power by determining a projected rate of power generation of the at least one power source, for example, 125-1 through 125-n (see FIGS. 1-2) and/or 130-1 through 130-n respectively based on, for example, the predicted weather.

In embodiments, the server assignment module 655 is configured to assign the first target state of charge or the second target state of charge corresponding to at least one charging unit, for example, 105-1 or each charging unit of the plurality of charging units, for example, 105-1 through 105-n respectively based on the determined operating conditions including, but not limited to, the determined cumulative current electrical load, the determined cumulative current count of the at least one connected BEM, the determined cumulative projected count of the at least one BEM expected to be connected to the one or more charging units, for example, 105-1 through 105-n, the determined current state of charge of the at least one BEM, and/or the determined cumulative projected electrical load.

In embodiments, the server assignment module 655 is configured to assign the first target state of charge when the determined cumulative current and/or projected count is greater than or equal to a predefined cumulative count threshold and/or the determined cumulative current and/or projected availability of power is less than a predefined cumulative power threshold. In embodiments, the server assignment module 655 is also configured to assign the first target state of charge when the determined cumulative current count of the at least one BEM, for example, 110-1 through 110-n connected to the one or more charging units, for example, 105-1 through 105-n is greater than or equal to the determined cumulative projected count of the at least one BEM connected to the one or more charging units at the upcoming or future time period or time duration. In embodiments, the server assignment module 655 is also configured to assign the first target state of charge when the determined cumulative current availability of power at the one or more power sources, for example, 125-1 through 125-n (see FIGS. 1-2) and/or 130-1 through 130-n is less than the determined cumulative projected availability of power at the upcoming or future time period or time duration.

In embodiments, the server assignment module 655 is configured to assign the second target state of charge when the determined cumulative current and/or projected count of the at least one BEM, for example, 110-1 through 110-n connected to the charging units, for example, 125-1 through 125-n (see FIGS. 1-2) and/or 130-1 through 130-n is less than the predefined cumulative count threshold. In embodiments, the server assignment module 655 is also configured to assign the second target state of charge when the cumulative projected availability of power at the one or more power sources, for example, 125-1 through 125-n (see FIGS. 1-2) and/or 130-1 through 130-n is greater than the predefined cumulative power threshold. In embodiments, the server assignment module 655 is also configured to assign the second target state of charge when the determined cumulative current count of the at least one BEM, for example, 110-1 through 110-n connected to the one or more charging units, for example, 105-1 through 105-n is less than the determined cumulative projected count of the at least one BEM expected to be connected to the one or more charging units at the upcoming or future time period or time duration. In embodiments, the assignment module 355 is also configured to assign the second target state of charge when the determined cumulative current availability of power is greater than the determined cumulative projected availability of power at the upcoming or future time period or time duration.

In embodiments, the server assignment module 655 is configured to identify different sets of charging units based on the determined operating conditions. For example, the server assignment module 655 is configured to identify a first set of charging units, for example, 105-1, 105-2 having the determined current and/or projected count of the at least connected BEM, the determined current and/or projected electrical load, and/or the determined current and/or projected availability of power from the power source 125, 130 corresponding to each charging unit or a combination of charging units of the first set of charging units within a first predefined range respectively. Similarly, the server assignment module 655 is configured to identify a second set of charging units, for example, 105-3 through 105-n having the determined current and/or projected count of the at least connected BEM, the determined current and/or projected electrical load, and/or the determined current and/or projected availability of power from the power source 125, 130 corresponding to each charging unit or a combination of charging units of the second set of charging units within a second predefined range respectively. In embodiments the second predefined range is greater than the first predefined range. For example, the server assignment module 655 is configured to identify the first set of charging units, for example, 105-1 through 105-2 having the determined current count of the connected BEM(s) within the first predefined range, for example, 1 to 2 BEMs, or less than 3 BEMs corresponding to each charging unit of the first set of charging units respectively. Similarly, the server assignment module 655 is configured to identify the second set of charging units, for example, 105-3 through 105-n having the determined current count of the connected BEM(s) within the second predefined range of, for example, 3 to 5 BEMs or greater than or equal to 3 BEMs corresponding to each charging unit of the second set of charging units respectively. As another example, the server assignment module 655 is configured to identify a third set of charging units, for example, 105-1 through 105-2 and a fourth set of charging units, for example, 105-3 through 105-n having the determined current electrical load on the charger power sources, for example, 125-1 and 125-2 (see FIGS. 1-2) of the third set of charging units, and the power sources, for example, 125-3 through 125-n (see FIGS. 1-2) of the fourth set of charging units within the first predefined range and the second predefined range associated with the current electrical load respectively.

In embodiments, the server assignment module 655 is configured to assign the first target state of charge to the first set of charging units and assign the second target state of charge to the second set of charging units, or assign the second target state of charge to the first set of charging units and assign the first target state of charge to the second set of charging units based on the identification. For example, the server assignment module 655 is configured to assign the first target state of charge to the first set of charging units when the determined current and/or projected count, the determined current and/or projected electrical load, and/or the determined current and/or projected availability of power corresponding to the each charging unit or a combination of charging units of the first set of charging units is within the second predefined range respectively. Similarly, the server assignment module 655 is configured to assign the second target state of charge to the second set of charging units when the determined current and/or projected count, the determined current and/or projected electrical load, and/or the determined current and/or projected availability of power corresponding to the each charging unit or a combination of charging units of the second set of charging units is within the first predefined range respectively. As another example, the server assignment module 655 is configured to assign the second target state of charge to the first set of charging units when the determined current and/or projected count, the determined current and/or projected electrical load, and/or the determined current and/or projected availability of power corresponding to the each charging unit or a combination of charging units of the first set of charging units is within the first predefined range respectively. Similarly, the server assignment module 655 is configured to assign the first target state of charge to the second set of charging units when the determined current and/or projected count, the determined current and/or projected electrical load, and/or the determined current and/or projected availability of power corresponding to the each charging unit or a combination of charging units of the second set of charging units is within the second predefined range respectively.

In embodiments, the server charging module 660 is configured to initiate charging of at least one BEM up to the first target state of charge for a first predefined time period or until the determined cumulative current electrical load, the determined cumulative current count of the at least one connected BEM, the determined cumulative projected count of the at least one BEM expected to be connected to each charging unit, and/or the determined cumulative projected electrical load is greater than a first predefined threshold respectively. For example, the server charging module 660 is configured to initiate charging of at least one BEM up to the first target state of charge until the determined cumulative current electrical load, the determined cumulative current count, the determined cumulative projected count, and/or the determined cumulative projected electrical load is greater than or equal to a cumulative current electrical load threshold, a cumulative current count threshold, a cumulative projected count threshold, and/or a cumulative projected electrical load threshold respectively. In embodiments, the server charging module 660 is configured to initiate charging of at least one BEM up to the second target state of charge for a second predefined time period, or until the determined cumulative current electrical load, the determined cumulative current count, the determined cumulative projected count, or the determined cumulative projected electrical load is less than a second predefined threshold respectively. For example, the server charging module 660 is configured to initiate charging of at least one BEM up to the second target state of charge until the determined cumulative current electrical load, the determined cumulative current count, the determined cumulative projected count, and/or the determined cumulative projected electrical load is less than the cumulative current electrical load threshold, the cumulative current count threshold, the cumulative projected count threshold, and/or the cumulative projected electrical load threshold respectively. In embodiments, the first predefined threshold and the second predefined threshold associated with the determined cumulative current electrical load, the determined cumulative current count, the determined cumulative projected count, and/or the determined cumulative projected electrical load may be same or different.

In an example, the server charging module 660 is configured to initiate charging of at least one BEM up to the first target state of charge until the determined cumulative current count of the at least one BEM connected to the one or more charging units, for example, 105-1 through 105-n is greater than or equal to the cumulative current count threshold of 15 BEM(s), for example, 110-1 through 110-15 as shown in FIG. 2. Similarly, the server charging module 660 is configured to initiate charging of at least one BEM up to the second target state of charge until the determined current cumulative count of the at least one BEM connected to is less than or equal to the cumulative current count threshold of 7 BEM(s), for example, 110-1 through 110-7 or less than 15 BEMs as shown in FIG. 1. As another example, the server charging module 660 is configured to initiate charging of at least one BEM up to the first target state of charge until the determined cumulative current count of the at least one BEM connected to the one or more charging units, for example, 105-1 through 105-n is greater than the determined cumulative projected count of the at least one BEM expected to be connected to the one or more charging units. Similarly, the server charging module 660 is configured to initiate charging of at least one BEM up to the second target state of charge until the determined cumulative current count of the at least one BEM connected to the one or more charging units, for example, 105-1 through 105-n is less than the determined cumulative projected count of the at least one BEM expected to be connected to the one or more charging units.

In yet another example, the server charging module 660 is configured to initiate charging of at least one BEM up to the first target state of charge until the determined cumulative current electrical load on the one or more power sources, for example, 125-1 through 125-n (see FIGS. 1-2) and/or 130-1 through 130-n is greater than or equal to the cumulative current electrical load threshold. Similarly, the server charging module 660 is configured to initiate charging of at least one BEM up to the second target state of charge until the determined cumulative current electrical load on the one or more power sources, for example, 125-1 through 125-n and/or 130-1 through 130-n, is less than the cumulative current electrical load threshold. In yet another example, the server charging module 660 is configured to initiate charging of at least one BEM up to the first target state of charge until the determined cumulative current electrical load is greater than the determined cumulative projected electrical load on the one or more power sources, for example, 125-1 through 125-n (see FIGS. 1-2) and/or 130-1 through 130-n. Similarly, the server charging module 660 is configured to initiate charging of at least one BEM up to the second target state of charge until the determined cumulative current electrical load on the one or more power sources, for example, 125-1 through 125-n (see FIGS. 1-2) and/or 130-1 through 130-n is less than the determined cumulative projected electrical load on the one or more power sources.

In embodiments, the server charging module 660 is configured to initiate charging of the at least one BEM connected to one or more sets of charging units identified by the server assignment module 655 up to the first target state of charge or the second target state of charge based on the identification of the first and second sets of charging units and the assignment. For example, the server charging module 660 is configured to initiate charging of the BEMs 110-4, 110-5, 110-6 through 110-7 connected to the charging units 105-2, 105-3, and 105-n respectively, as shown in FIG. 1, up to the second target state of charge based on the identification or when, for example, the determined current count of the BEM(s) connected to the charging units 105-2, 105-3, and 105-n are less than the first predefined threshold of, for example, 1 to 2 BEMs or 3 BEMs respectively or less than the cumulative current count threshold of, for example, 4 BEMs connected to the charging units, for example, 105-2, 105-3, and 105-n. Similarly, the server charging module 660 is configured to initiate charging of the BEMs 110-1 through 110-3 connected to the charging unit 105-1, as shown in FIG. 1, up to the first target state of charge based on the identification or when, for example, the determined current count of the BEM(s) connected to the charging unit, for example, 105-1 is greater than or equal to the second predefined threshold of, for example, 3 BEMs respectively, or greater the cumulative current count threshold of 3 BEMs. In yet another example, the server charging module 660 is configured to initiate charging of the BEMs 110-4 and 110-11, 110-5 and 110-12 connected to the charging units 105-2, 105-3 respectively, as shown in FIG. 2, up to the second target state of charge based on the identification or when, for example, the determined current count of the BEM(s) connected to the charging units 105-2, 105-3, and 105-n are less than the first predefined range of, for example, 1 to 2 BEMs respectively, or the cumulative current count threshold of, for example, 4 BEMs or 6 BEMs Similarly, the server charging module 660 is configured to initiate charging of the BEMs 110-1 through 110-3 and 110-8 through 110-10, 110-6 through 110-7 and 110-13 through 110-n connected to the charging units 105-1 and 105-n, as shown in FIG. 2, up to the first target state of charge based on the identification or when, for example, the determined current count of the BEM(s) connected to the charging unit 105-1 is greater than or equal to the second predefined range of, for example, 3 BEMs, or the cumulative current count threshold of, for example, 6 BEMs.

In embodiments, the server charging module 660 is configured to initiate charging of the at least one BEM, for example, 110-1 via the corresponding charging unit, up to the second target state of charge after the first predefined time period or when the determined cumulative current electrical load, the determined cumulative current count, or the determined cumulative projected electrical load is less than the first predefined threshold. In embodiments, the server charging module 660 is also configured to initiate charging of the at least one BEM, for example, 110-1 via the corresponding charging unit, up to the first target state of charge after the second predefined time period or when the determined cumulative current electrical load, the determined cumulative current count, or the determined cumulative projected electrical load is greater than or equal to the second predefined threshold.

### INDUSTRIAL APPLICABILITY

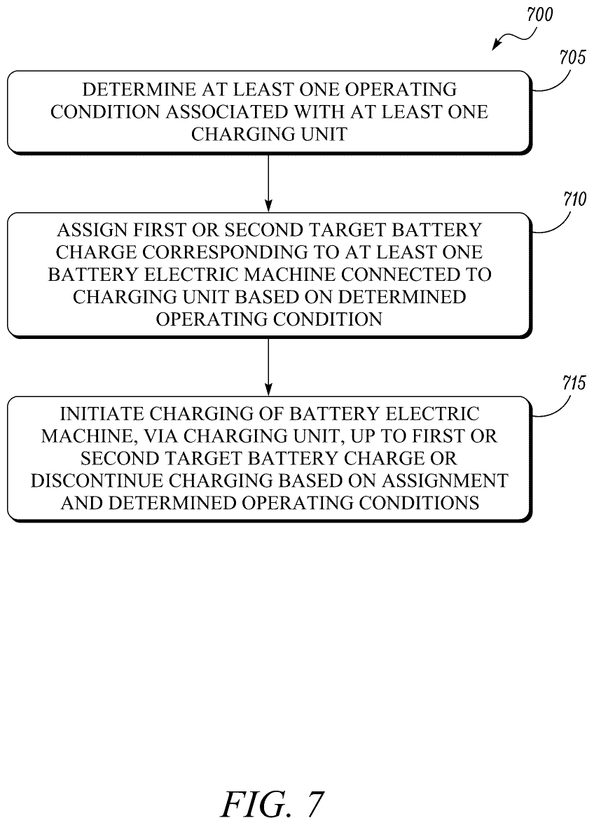

Referring to FIG. 7, a method 700 for managing a plurality of machines via the charger control system(s), for example, 145-1 through 145-n of the charging units 105-1 through 105-n, respectively or the server control system 150 employed within the worksite 100 of FIGS. 1-2 is disclosed. The charger control system(s), for example, 145-1 through 145-n and the server control system 150 are referred to herein as the ‘control system 145, 150’. At step 705, the control system 145, 150 is configured to determine at least one operating condition of at least one or a corresponding charging unit. The at least operating condition includes a current electrical load on the power source 125, 130, a current availability of the electrical power from the power source 125, 130, a current time period of operation of the at least one or corresponding charging unit, a current count of at least one BEM connected to the at least one or corresponding charging unit, a current state of charge of the at least one connected BEM, a projected electrical load on the power source 125, 130, and/or a projected availability of the electrical power from the power source 125, 130 over a predefined time period. At step 710, the control system 145, 150 is configured to assign a first target state of charge or second target state of charge corresponding to the at least one connected BEM, for example, 110-1 based on the at least one determined operating condition. The second target state of charge is greater than the first target state of charge by at least a predefined threshold. At step 715, the control system 145, 150 is configured to charge, via the at least one or corresponding charging unit, the at least one connected BEM up to the first target state of charge or the second target state of charge or discontinue the charging based on the assignment and the at least one determined operating condition.

It will be apparent that the control system 145, 150 and the method 700 of the present disclosure enable optimal electrical load management such that the one or more BEM(s), for example, 110-1 through 110-n are charged to a higher target state of charge of the first target state of charge and the second target state of charge during lean periods of reduced electrical load on the power sources, for example, 125-1 through 125-n of the charging unit(s), for example, 105-1 through 105-n and/or the independent power sources, for example, 130-1 through 130-n, increase in availability of current power from the power sources, for example, 125-1 through 125-n and/or 130-1 through 130-n, and/or reduced current count of the BEM(s) connected to the charging unit(s), for example, 105-1 through 105-n. Similarly, in comparison, as a result of the optimal electrical load management, the one or more BEMs, for example, 110-1 through 110-n are charged to a lower target state of charge of the first target state of charge and the second state of charge during peak periods of increased electrical load on the power sources associated with the charging units and/or the independent power sources, reduced availability of the current power at the charging units and/or the independent power sources, and/or an increased current count of the BEM(s), for example, 110-1 through 110-n connected to the charging units. The optimal electrical load management by the control system 145, 150 and the method 700 of the present disclosure also helps minimize queuing of the BEM(s), for example, 110-1 through 110-n at the charging unit(s) for charging during the peak periods since the BEM(s) are sufficiently charged in advance to the higher target state of charge of the first target state of charge and the second target state of charge during the lean periods to compensate for the peak periods. Further, the control system 145, 150 and the method 700 of the present disclosure also help in continuous movement and dispatch of the BEM(s) from the charging units during the peak periods since the BEM(s) are charged up to lower target state of charge of the first target state of charge and the second target state of charge, which, in turn, reduces the waiting periods for charging of the BEMs at the charging units and minimizes production delays. The control system 145, 150 and the method 700 also enable optimal task assignment to the BEM(s) based on the lean and peak periods and thereby, improve production efficiency by ensuring that the BEM(s) are continuously utilized within the worksite 100 with minimal delays and/or idle times. Further, the control system 145, 150 and the method 700 of the present disclosure may also help reduce production costs in terms of power tariffs during the peak periods due to the optimal electrical load management of the power sources, for example, 125-1 through 125-n, and/or 130-1 through 130-n. Furthermore, the control system 145, 150 and the method 700 of the present disclosure help in optimal utilization of the available power during the lean and the peak periods such that under or over utilization of the available power is minimised, thereby, improving the production efficiency. In addition, the control system 145, 150 and the method 700 of the present disclosure help optimally manage the electrical load within the worksite 100 based on an existing power distribution infrastructure including, but not limited to, the power sources 125, 130 and thereby, delay or avoid actions pertaining to a further upgrade of the existing power distribution infrastructure and/or introduction of supplementary power distribution infrastructure within the worksite 100. Consequently, the control system 145, 150 and the method 700 of the present disclosure help avoid associated infrastructure upgrade costs and/or investment costs related to the introduction of the supplementary power distribution infrastructure within the worksite 100.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

What is claimed is:

1. A control system for electrical load management, comprising:
a processor;
a memory for storing instructions that when executed by the processor, causes the processor to:
determine at least one operating condition associated with at least one charging unit in communication with the processor, wherein the at least operating condition comprises at least one of:
a current electrical load on at least one power source associated with the at least one charging unit,
a current availability of electrical power from the at least one power source,
a current time period of operation of the at least one charging unit,
a current count of at least one battery electric machine connected to the at least one charging unit and in communication with the processor,
a current state of charge of the at least one connected battery electric machine,
a projected electrical load on the at least one power source, or
a projected availability of the electrical power from the at least one power source over a predefined time period;
assign a first target state of charge or a second target state of charge corresponding to the at least one connected battery electric machine based on the at least one determined operating condition, wherein the second target state of charge is greater than the first target state of charge by at least a predefined threshold; and
initiate charging of the at least one battery electric machine, via the at least one charging unit, up to the first target state of charge or the second target state of charge, or discontinue the charging based on the assignment and the at least one determined operating condition.

2. The control system of claim 1, wherein the processor is configured to determine the projected electrical load by determining at least one of:
at least one historical electrical load on the at least one power source over a historical time period or discrete time durations;
a projected count of the at least one battery electric machine expected to be connected to the at least one charging unit over the predefined time period; or
a projected count of at least one electrical equipment or machinery expected to be connected to the at least one power source in addition to the at least one battery electric machine.

3. The control system of claim 1, wherein the processor is configured to determine the projected availability of the electrical power by determining at least one of:
a predicted weather condition over the predefined time period;
a projected count of the at least one battery electric machine expected to be connected to the at least one charging unit over the predefined time period; or
a projected count of at least one electrical equipment or machinery expected to be connected to the at least one power source in addition to the at least one battery electric machine.

4. The control system of claim 1, wherein the first target state of charge or the second target state of charge is within a predefined range of state of charge or within a linear charging range, the linear charging range corresponding to a range within which an increase in the state of charge of the at least one BEM is substantially linear corresponding to a constant electrical current drawn from the at least one power source of the at least one charging unit by the at least one BEM during charging.

5. The control system of claim 1, wherein processor is configured to:
assign at least one task to the at least one battery electric machine;
determine an estimated depth of discharge of the at least one battery electric machine after completion of the at least one assigned task; and
assign the first target state of charge corresponding to the at least one battery electric machine based on the determined estimated depth of discharge such that the at least one battery electric machine is capable of completing the at least one assigned task and a state of charge of the at least one battery electric machine after completion of the at least one assigned task is greater than or equal to at least 10 percent of a maximum battery capacity of the at least one battery electric machine after completion of the at least one task.

6. The control system of claim 1, wherein the processor is configured to:
assign at least one task to the at least one battery electric machine;
determine an estimated increase in percentage of a state of charge of the at least one battery electric machine via regenerative braking based on the at least one assigned task; and
assign the second target state of charge such that the state of charge of the at least one battery electric machine is less than or equal to 90 percent of a maximum battery capacity of the at least one battery electric machine after the estimated percentage of increase.

7. The control system of claim 1, wherein the processor is configured to determine and assign at least one task to be performed at a given point in time or within a given time duration by the at least one battery electric machine based on the assigned first target state of charge or the assigned second target state of charge.

8. The control system of claim 1, comprising at least one independent power source in communication with the processor and a plurality of charging units of the at least one charging unit, wherein processor is configured to:
determine at least one of a cumulative current electrical load on the plurality of charging units and the at least one independent power source, a cumulative current count of the at least one battery electric machine connected to the plurality of charging units, a cumulative current count of at least one electrical device or machinery connected to the at least one independent power source, a cumulative projected count of the at least one battery electric machine expected to be connected to the plurality of charging units; a cumulative projected count of the at least one electrical device or machinery expected to be connected to the plurality of charging units, or a cumulative projected electrical load on the plurality of charging units and the at least one independent power source;
assign the first target state of charge or the second target state of charge corresponding to the at least one battery electric machine respectively based on at least one of the determined cumulative current electrical load on the plurality of charging units and the at least one independent power source, the determined cumulative current count of the at least one battery electric machine and the at least one electrical device or machinery, the determined cumulative projected count of the at least one battery electric machine and the at least one electrical device or machinery, or the determined cumulative projected electrical load on the plurality of charging units and the at least one independent power source; and
initiate charging of at least one battery electric machine, via at least corresponding charging unit of the plurality of charging units, based on the assignment up to the first target state of charge for a first predefined time period or until at least one of the determined cumulative current electrical load on the plurality of charging units and the at least one independent power source, the determined cumulative current count of the at least one battery electric machine and the at least one electrical device or machinery, the determined cumulative projected count of the at least one battery electric machine and the at least one electrical device or machinery, or the determined cumulative projected electrical load on the plurality of charging units and the at least one independent power source is greater than a first predefined threshold respectively; or
initiate charging of at least one battery electric machine, via the corresponding charging unit, based on the assignment up to the second target state of charge for a second predefined time period, or until at least one the determined cumulative current electrical load on the plurality of charging units and the at least one independent power source, the determined cumulative current count of the at least one battery electric machine and the at least one electrical device or machinery, the determined cumulative projected count of the at least one battery electric machine and the at least one electrical device or machinery, or the determined cumulative projected electrical load on the plurality of charging units and the at least one independent power source is less than a second predefined threshold respectively.

9. The control system of claim 8, wherein the processor is configured to:
initiate charging of the at least one battery electric machine, via the corresponding charging unit, up to the second target state of charge after the first predefined time period or when at least one of the determined cumulative current electrical load on the plurality of charging units and the at least one independent power source, the determined cumulative current count of the at least one battery electric machine and the at least one electrical device or machinery, the determined cumulative projected count of the at least one battery electric machine and the at least one electrical device or machinery, or the determined cumulative projected electrical load on the plurality of charging units and the at least one independent power source is less than or equal to the first predefined threshold, or
initiate charging of the at least one battery electric machine, via the corresponding charging unit, up to the first target state of charge after the second predefined time period or when at least one of the determined cumulative current electrical load on the plurality of charging units and the at least one independent power source, the determined cumulative current count of the at least one battery electric machine and the at least one electrical device or machinery, the determined cumulative projected count of the at least one battery electric machine and the at least one electrical device or machinery, or the determined cumulative projected electrical load on the plurality of charging units and the at least one independent power source is greater than or equal to the second predefined threshold.

10. The control system of claim 1, wherein the processor is configured to:
determine a probability of a battery capacity of the at least one battery electric machine being less than a predefined threshold corresponding to at least one task based on the determined current state of charge; and
determine the first target state of charge and the second target battery charge to perform the at least one task based on the determined probability.

11. A charging unit, comprising:
at least one power source;
at least one power outlet; and
a control system in communication with the at least one power source and the at least one power outlet, wherein the control system is configured to:
determine at least one operating condition of the at least one charging unit, wherein the at least operating condition comprises at least one of a current electrical load on the at least one power source, a current availability of electrical power from the at least one power source, a current time period of operation of the at least one charging unit, a current count of at least one battery electric machine connected to the at least one charging unit via the at least one power outlet and in communication with the control system, a current state of charge of the at least one connected battery electric machine, a projected electrical load on the at least one charging unit, or a projected availability of the electrical power from the at least one power source over a predefined time period;
assign a first target state of charge or second target state of charge corresponding to the at least one connected battery electric machine based on the at least one determined operating condition, wherein the second target state of charge is greater than the first target state of charge by at least a predefined threshold; and
initiate charging of the at least one battery electric machine, via the at least one power source and the at least one power outlet, up to the first target state of charge or second target state of charge, or discontinue the charging based on the assignment and the at least one determined operating condition.

12. A server for electrical load management of at least one power source, comprising:
a control system;
at least one independent power source in communication with the at least one control system; and
at least one charging unit in communication with the control system, wherein the control system is configured to:
determine at least one operating condition of the at least one charging unit and the at least one independent power source, wherein the at least operating condition comprises at least one of a current electrical load on at least one power source associated with the at least one charging unit, a current electrical load on the at least one independent power source, a current availability of electrical power from the at least one power source and the at least one independent power source, a current time period of operation of the at least one charging unit and the at least one independent power source, a current count of at least one battery electric machine connected to the at least one charging unit and in communication with the control system, a current count of at least one electrical device or machinery connected to the at least one independent power source, a current state of charge of the at least one connected battery electric machine, a projected electrical load on the at least one power source and the at least one independent power source, or a projected availability of the electrical power from the at least one power source and the at least one independent power source over a predefined time period;
assign a first target state of charge or second target state of charge corresponding to the at least one connected battery electric machine based on the at least one determined operating condition, wherein the second target state of charge is greater than the first target state of charge by at least a predefined threshold; and
initiate charging of the at least one battery electric machine, via the at least one charging unit, up to the first target state of charge or second target state of charge, or discontinue the charging based on the assignment and the at least one determined operating condition.

13. A method for electrical load management, comprising:
determining, via a processor of a control system, at least one operating condition of the at least one charging unit in communication with the processor, wherein the at least operating condition comprises at least one of a current electrical load on at least one power source associated with the at least one charging unit, a current availability of the electrical power from at least one power source, a current time period operation of the at least one charging unit, a current count of at least one battery electric machine connected to the at least one charging unit, a current state of charge of the at least one connected battery electric machine, a projected electrical load on the at least one power source, or a projected availability of the electrical power at the at least one power source over a predefined time period;
assigning, via the processor, a first target state of charge or second target state of charge corresponding to the at least one connected battery electric machine based on the at least one determined operating condition, wherein the second target state of charge is greater than the first target state of charge by at least a predefined threshold; and
charging, via at least one charging unit, the at least one battery electric machine up to the first target state of charge or second target state of charge or discontinue the charging based on the assignment and the at least one determined operating condition.

14. The method of claim 13, wherein the determining of the projected electrical load comprises at least one of:
analyzing at least one historical electrical load on the at least one power source over a historical time period or time durations;
determining a projected count of the at least one battery electric machine expected to be connected to the at least one charging unit over the predefined time period; or
determining a projected count of at least one electrical equipment or machinery expected to be connected to the at least one power source in addition to the at least one battery electric machine.

15. The method of claim 13, wherein the determining of the projected availability of the electrical power comprises determining at least one of:
a predicted weather condition over the predefined time period;
a projected count of the at least one battery electric machine expected to be connected to the at least one charging unit over the predefined time period; or
a projected count of at least one electrical equipment or machinery expected to be connected to the at least one power source in addition to the at least one battery electric machine.

16. The method of claim 13, comprising:
determining, via the processor, an estimated depth of discharge of the at least one battery electric machine after completion of the at least one assigned task; and
assigning, via the processor, the first target state of charge corresponding to the at least one battery electric machine based on the determined estimated depth of discharge such that the at least one battery electric machine is capable of completing the at least one assigned task and a state of charge of the at least one battery electric machine after completion of the at least one assigned task is greater than or equal to at least 10 percent of a maximum battery capacity of the at least one battery electric machine after completion of the at least one task.

17. The method of claim 16, comprising:
assigning, via the processor, at least one task to the at least one battery electric machine;
determining, via the processor, an estimated increase in percentage of a state of charge of the at least one battery electric machine via regenerative braking based on the at least one assigned task; and
assigning, via the processor, the second target state of charge such that the state of charge of the at least one battery electric machine is less than or equal to 90 percent of a maximum battery capacity of the at least one battery electric machine after the determined estimated percentage of increase.

18. The method of claim 13, comprising: determining and assigning, via the processor, at least one task to be performed at a given point in time or within a given time duration by the at least one battery electric machine based on the assigned first target state of charge or the assigned second target state of charge.

19. The method of claim 13, wherein the at least one charging unit corresponds to a plurality of charging units, and the method comprises:
determining, via the processor, at least one of a cumulative current electrical load on the plurality of charging units, a cumulative current count of the at least one battery electric machine connected to the plurality of charging units, or a cumulative projected electric load on the plurality of charging units;
assigning, via the processor, the first target state of charge or the second target state of charge corresponding to the plurality of charging units respectively based on at least one of the determined cumulative current electrical load, the determined cumulative current count, the determined cumulative projected count, or the determined cumulative projected electrical load; and
charging at least one battery electric machine, via a corresponding charging unit of the plurality of charging units, up to the first target state of charge for a first predefined time period or until at least one of the determined cumulative current electrical load, the determined cumulative current count, the determined cumulative projected count, or the determined cumulative projected electrical load is greater than a first predefined threshold; or
charging at least one battery electric machine, via the corresponding charging unit of the plurality of charging units, up to the second target state of charge for a second predefined time period, or until at least one of the determined cumulative current electrical load, the determined cumulative current count, the determined cumulative projected count, or the determined cumulative projected electrical load is less than a second predefined threshold.

20. The method of claim 19, comprising:
charging at least one battery electric machine, via a corresponding charging unit of the plurality of charging units, up to the second target state of charge after the first predefined time period or when at least one of the determined cumulative current electrical load, the determined cumulative current count, the determined cumulative projected count, or the determined cumulative projected electrical load is less than or equal to the first predefined threshold, or
charging at least one battery electric machine, via the corresponding charging unit of the plurality of charging units, up to the first target state of charge after the second predefined time period or when at least one of the determined cumulative current electrical load, the determined cumulative current count, the determined cumulative projected count, or the determined cumulative projected electrical load is greater than or equal to the second predefined threshold.
